(19) United States
(12) Patent Application Publication
(10) Pub. No.: US 2026/0155992 A1
(43) Pub. Date: Jun. 4, 2026

(54) CONTENT INTEGRITY VERIFICATION

(71) Applicant: American Express Travel Related Services Company, Inc., New York, NY (US)

(72) Inventors: Alaric M. Eby, Scottsdale, AZ (US); Andras L. Ferenczi, Scottsdale, AZ (US); Hilary Packer, New York, NY (US)

(21) Appl. No.: 18/963,852

(22) Filed: Nov. 29, 2024

(51) Int. Cl. H04L 9/32; G06F 21/64

(52) U.S. Cl. CPC H04L 9/3247; G06F 21/64

(57) ABSTRACT

Disclosed are various embodiments for securely and efficiently transmitting various types of digital content (e.g., images, audio, video, etc.) with added assurance regarding the integrity and similarity to the original form of the content. Content to be transmitted can be encoded into a latent encoded representation of the content using a trained AI encoder, thereby reducing the size or compressing the content. A digital signature can also be applied to the encoded representation. The sender can send the original content and the signed encoded representation to a receiver. The receiver can encode the received content using the AI encoder and compare the encoded representations to determine similarities. In addition, the receiver side can validate the digital signature of the received encoded representation. The comparison of the encoded representations and the validation of the digital signature can both be used to validate the integrity of the received content.

### BACKGROUND

Transferring content (e.g., images, audio, video, etc.) over a network can face various challenges with respect to maintaining the integrity of the content being transferred. In some examples, the content being transferred can be subject to significant alterations due to data loss and/or data tampering of the content during the transfer thereby affecting the integrity of the content. Maintaining the integrity of the content being transferred ensures that the correct content is being sent, the unregistered use and manipulation of the data can be controlled, and that the correct content is being used by the receiver of the content.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIGS. 1A and 1B are drawings of example network environments according to various embodiments of the present disclosure.

FIG. 2 is a sequence diagram illustrating examples of functionality in the network environments of FIGS. 1A and 1B according to various embodiments of the present disclosure. In particular, the sequence diagram of FIG. 2 depicts the functionality associated with securely and efficiently transmitting content between a sender and a receiver with added assurance regarding the integrity and similarity to the original form of the content.

FIGS. 3A and 3B are sequence diagrams illustrating examples of functionality in the network environments of FIGS. 1A and 1B according to various embodiments of the present disclosure. In particular, the sequence diagrams of FIGS. 3A and 3B depicts the functionality associated with securely and efficiently transmitting content and a content description between a sender and a receiver with added assurance regarding the integrity and similarity to the original form of the content.

FIG. 4 is a flowchart illustrating one example of functionality implemented as portions of an application executed in a computing environment in the network environment of FIGS. 1A and 1B according to various embodiments of the present disclosure.

### DETAILED DESCRIPTION

Disclosed are various approaches for securely and efficiently transmitting various types of digital content (e.g., images, audio, video, etc.) with added assurance regarding the integrity and similarity to the original form of the content. Through the use of artificial intelligence (AI) model encoding and digital signatures, the sender and receiver sides can ensure that the integrity of transmitted content has not been compromised and that the received content is similar to the original form.

In various examples, content that is to be transmitted to a receiver can be obtained and encoded into a latent encoded representation of the content using a trained AI encoder, thereby reducing the size or compressing the content. A digital signature can also be applied to the encoded representation. The sender can send content data including the original content and the signed encoded representation to a receiver. To ensure the integrity of the content, the receiver can encode the received content using the AI encoder and compare the encoded representations (e.g., received encoded representation and receiver-side generated encoded representation) to determine similarities. In addition, the receiver side can validate the digital signature of the received encoded representation. The comparison of the encoded representations and the validation of the digital signature can both be used to validate the integrity of the received content.

Message authentication codes (MACs) can be used for the transmission of sensitive data with the purpose of preventing data tampering. The present disclosure provides an alternative to MACs by avoiding the hashing of large media content by substituting the cryptographic hash of a MAC with the output of an AI encoder that is trained to compress the content nondeterministically while within controllable boundaries. The encoded payload can then be encrypted with the sender's private key thereby generating a digital signature. Additionally, in various examples, the present disclosure provides an approach that can distribute computing resource utilization between graphic processing unit (GPU) clusters and central processing units (CPUs), with respect to the processing of the encoded representations that are output from the encoder. As such, CPU usage can be offloaded and CPU/GPU utilization can be optimized with little to no compromise to the security of the transmitted data. For example, autoencoders can leverage GPU resources for generating and processing the encoded representations while CPU resources can be used to perform other tasks (e.g., validating the encoded content).

The present disclosure improves on traditional methods by using autoencoders for compressing the content. An autoencoder is a type of artificial neural network that is used to learn efficient representations of data, typically for the purpose of dimensionality reduction. An autoencoder can comprise two parts: an encoder that compresses the input data into a latent space representation, and decoder that reconstructs the original data from the compressed representation. Benefits for using AI autoencoders for compressing media files include improved compression efficiency, enhanced scalability, better preservation of important information, and noise reduction and data denoising. In particular, autoencoders can learn to represent data in a more efficient manner by identifying and extracting only the essential features needed for reconstruction, leading to smaller file sizes without significant loss in quality. By reducing the dimensionality of the data, autoencoders make it easier to work with large datasets or process them faster on limited computing resources. Since autoencoders focus on preserving essential features during compression, they can maintain higher fidelity compared to traditional compression methods, which often discard some information to achieve smaller file sized. In addition, autoencoders can help improve the quality of media files by removing unwanted noise while still retaining important details in the data.

From a computational perspective, content compression via AI autoencoders to reduce the size of the content before hashing and signing can be more optimal than hashing the very large content directly and then encrypting it. For example, where content is directly hashed and signed, hashing a verify large media file directly requires reading and processing of the entire file. The computation cost is proportional to the file size. Further larger files take more time to hash due to the volume of data.

Alternatively, compressing the content using AI encoders involves encoding the content into a latent representation which can be computationally intensive but more efficient than hashing large files directly because the autoencoder significantly reduces the size of the data and once compressed, the size of the data to be hashed is much smaller. Furthermore, hashing the encoded data is computationally less intensive due to the reduced size of the data and encrypting the smaller hash generated from the compressed data is quick and efficient. Although the initial computation load for compression can be high, the use of autoencoders reduces the data size significantly thereby increasing the time and costs for the subsequent steps of hashing and encryption.

Various embodiments of the present disclosure further help mitigate prompt injection and interference issues that can occur during the transfer of content. The improvements can include enhanced security, data integrity verification, compatibility and consistency checks, and/or combined signature validation. For example, the content being transferred may correspond to a press release by a chief executive officer of a company and the press release may contain earnings data. In this situation, the company would want to ensure that the received content has been securely transmitted without any interference of modification. By using digital signatures, only authorized users can be permitted to have access to sensitive data or images exchanged during interactions (e.g., application programming interface (API) calls). This ensures that unauthorized parties cannot modify or inject prompts into the communication process. In various examples, the present disclosure verifies the integrity of the transmitted content by comparing newly encoded representations with signed encodings received from the sender, identifying any tampering or modifications during transit. Any attempts to interfere with the payload can be flagged as invalided. Use of the same AI encoder model on both the sending and receiving sides ensures compatibility and reduces potential errors or inconsistencies that can arise from using different models. This helps maintain consistency across transmitted payloads and prevents unexpected interference in the received data. Finally, the unified signature of the present disclosure for multiple types of media within a single document allows for comprehensive verification of the entire payload's integrity. Any unauthorized alterations to the payload will result in invalid signatures, alerting users about potential tampering or injection attempts.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

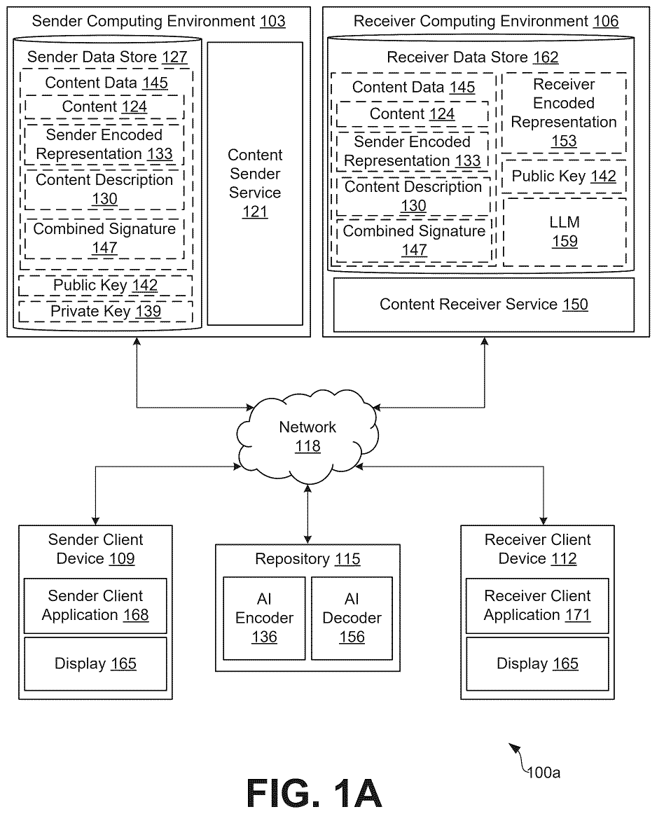

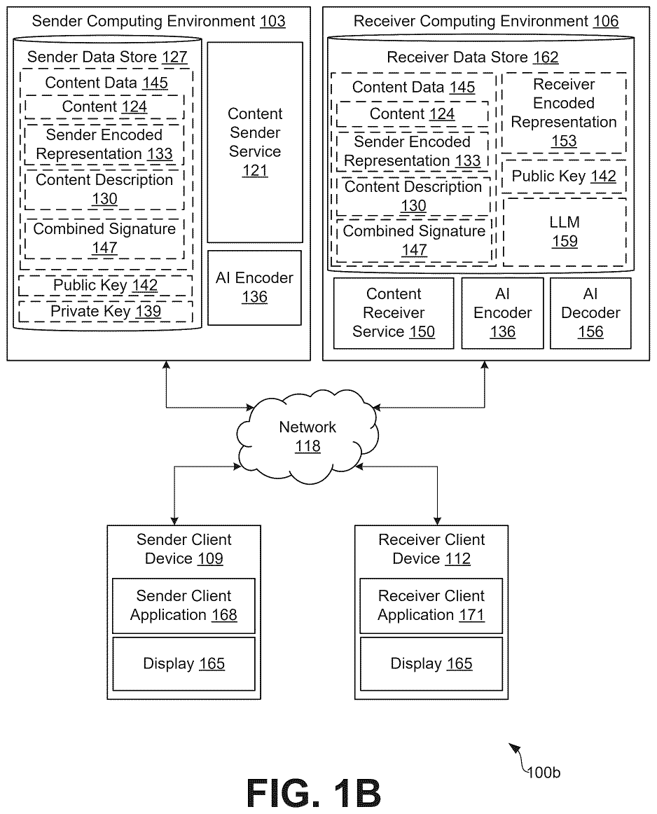

With reference to FIGS. 1A and 1B, shown are example network environments 100 (e.g., 100a and 100b) according to various embodiments. The network environment 100a of FIG. 1A can include a sender computing environment 103, a receiver computing environment 106, a sender client device 109, a receiver client device 112, and a repository 115, which can be in data communication with each other via a network 118. The network environment 100b of FIG. 1B differs from 1B in that the network environment 100b of FIG. 1B does not include a repository 115 and the AI encoder 136 and AI decoder 156 are local to the sender computing environment 103 and receiver computing environment 106.

The network 118 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 118 can also include a combination of two or more networks 118. Examples of networks 118 can include the Internet, intranets, extranets, virtual private networks (VPNs), and similar networks.

The sender computing environment 103 and the receiver computing environment 106 can each include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the sender computing environment 103 and the receiver computing environment 106 can each employ a plurality of computing devices that can be arranged in one or more server banks or computer banks or other arrangements. Such computing devices can be located in a single installation or can be distributed among many different geographical locations. For example, sender computing environment 103 and/or the receiver computing environment 106 can include a plurality of computing devices that together can include a hosted computing resource, a grid computing resource or any other distributed computing arrangement. In some cases, the sender computing environment 103 and/or the receiver computing environment 106 can correspond to an elastic computing resource where the allotted capacity of processing, network, storage, or other computing-related resources can vary over time.

In various examples, the sender computing environment 103 corresponds to the computing environment associated with a sender of content and the receiver computing environment 106 corresponds to a computing environment associated with a receiver of content. However, it should be appreciated that in various examples, a sender of content can also be a receiver of content and vice versa. Therefore, in various examples, the sender computing environment 103 can include one or more aspects of functionality of the receiver computing environment 106 and/or the receiver computing environment 106 can include one or more aspects of functionality of the sender computing environment 103.

Various applications or other functionality can be executed in the sender computing environment 103. The components executed on the sender computing environment 103 include a content sender service 121, and other applications, services, processes, systems, engines, or functionality not discussed in detail herein.

The content sender service 121 can be executed to obtain and process content 124 (e.g., image, video, audio, etc.) for transfer to a receiving party. For example, the content sender service 121 can obtain the content 124 to be transferred from the sender data store 127 or from the sender client device 109. In some examples, the sender content service 121 can include an artificial intelligence gateway that is invoked in response to an application programming interface (API) call from the sender client device 109. In this example, the API call can include the content 124, a location of the content 124, a content description 130, a receiver identifier, and/or other information to prepare the content 124 for transfer to a receiving party.

In response to obtaining the content 124, the content sender service 121 can generate a sender encoded representation 133 by encoding the content 124. In various examples, the content sender service 121 can apply the content 124 as an input to an AI encoder 136 that is trained to encode the content type of the content 124. As illustrated in FIG. 1A, the AI encoder 136 can be stored in a repository 115 that is in data communication with the sender computing environment 103. In other examples, as illustrated in FIG. 1B, the AI encoder 136 can be local to the sender computing environment 103 and can be executed within the sender computing environment 103.

In various examples, the sender encoded representation 133 can comprise a latent encoded representation of the content 124. For example, the AI encoder 136 can be trained to generate a latent space representation of the content 124 that corresponds to a compressed representation of the content 124 in the form of one or more feature vectors. The feature vectors can capture the important characteristics of the content 124 which can be used for comparison and/or reconstruction. Accordingly, the content 124 can be reduced in size and/or compressed through the use of the AI encoder 136.

The content sender service 121 can generate a signature for the sender encoded representation 133 of the content 124 that is output from the AI encoder 136. For example, the content sender service 121 can use at least one of Rivest-Shamir-Adelman (RSA), digital signature algorithm (DSA), Elliptic Curve Digital Signature algorithm (ECDSA) or another digital signature algorithm to generate the digital signature of the encoded representation of the content 124. In some examples, the content sender service 121 can digitally sign the encoded representation using the private key 139 of a sender associated with the sender computing environment 103 and/or sender client device 109 and the corresponding public key 142 can be used by the receiving entity for validation.

In some examples, the content sender service 121 can obtain a content description 130 of the content 124. The content description 130 can comprise a text description for the content and can be used for additional verification of the content 124. For example, if the content 124 comprises an image of snowcapped mountains, the text description may indicate “The image is of snowcapped mountains.” In various examples, the content sender service 121 can encrypt the content description 130 or otherwise digitally sign the content description 130. For example, a hash function can be applied to the content description 130 followed by the application of a digital signature algorithm to generate the digital signature of the content description 130. In various examples, the private key 139 is used to generate the digital signature of the content description 130.

In various examples, the content sender service 121 can generate content data 145 to transfer to the receiving entity. The content data 145 can include the content 124, the sender encoded representation 133, the content description 130, and/or other data. In some examples, the content sender service 121 can combine the signatures of the sender encoded representation 133 and the content description 130 to generate a combined signature 147. For example, the content sender service 121 can concatenate or merge the generated signatures into a single combined signature 147. This concatenated signature 147 can represent the overall integrity of the content data 145.

In some examples, the content 124 to be transferred can contain different types of content 124. For example, the content 124 can include video and audio. In this example, the content sender service 121 can generate a sender encoded representation 133 of the audio and a sender encoded representation 133 of the video using one or more AI encoders 136 trained for the different types of content 124. The content sender service 121 can generate a digital signature for each sender encoded representation 133. In various examples, the content sender service 121 can generate the combined signature to include the signatures of each encoded representation 133 and content description 130.

To create a combined signature 147 for multiple types of content 124 (or just one type of content 124 and the content description 130), the content sender service 121 can combine all the individual signatures (e.g., digital signatures for content 124, and encrypted hash for the content description 130 or text) into a single string or data structure. The content sender service 121 can then apply a secure cryptographic hash function to the concatenated string or combined data structure. Application of the secure cryptographic hash function can generate a unique and compact representation of the combined signatures. The content sender service 121 can then encrypt the resulting hash value using an asymmetric encryption algorithm (e.g., RSA, DSA, ECDSA, etc.). The encrypted hash serves as the combined signature 147 representing the integrity of all content types included in the content data 145.

Upon generating the content data 145, the content sender service 121 can transmit the content data 145 to the recipient of the content 124. For example, the content sender service 121 can transmit the content data 145 including the content 124, the sender encoded representation 133, the content description 130, and/or the combined signature 147 to the receiver computing environment 106 and/or the receiver client device 112. In various examples, the content receiver service 150 can comprise an AI gateway service that can act as an intermediary between the sender computing environment 103 and the receiver client device 112 and can be used to verify the integrity of the content 124 and content data 145 prior to use of the content 124 by the recipient.

Also, various data is stored in a sender data store 127 that is accessible to the sender computing environment 103. The sender data store 127 can be representative of a plurality of sender data stores 127, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the sender data store 127 is associated with the operation of the various applications or functional entities described below. This data can include content data 145, a public key 142, a private key 139, and potentially other data.

The content data 145 can represent data associated with content 124 that is to be transmitted from the sender computing environment 103 to a recipient device (e.g., receiver computing environment 106, receiver client device 112, etc.). In various examples, the content data 145 can be generated by the content sender service 121. The content data 145 can include content 124, a sender encoded representation 133, a content description 130, a combined signature 147, and/or other data.

The content 124 can include text, images, graphics, audio, video, and/or other type of media or multimedia. In various examples, the content 124 is provided by the sender client device 109 and/or other device and stored in the sender data store 127. In other examples, the content 124 can be generated within the sender computing environment 103 and stored within eh sender data store 127.

The sender encoded representation 133 can comprise the output of an AI encoder 136. For example, the AI encoder 136 can be trained to generate a latent space representation of the content 124 that corresponds to a compressed representation of the content in the form of one or more feature vectors. The feature vectors can capture the important characteristics of the content 124 which can be used for comparison and/or reconstruction. Accordingly, the content 124 can be reduced in size and/or compressed using the AI encoder 136.

The content description 130 can comprise a text description of the content 124 and can be used for verification of the content 124. For example, if the content 124 comprises an image of snowcapped mountains, the content description 130 may include “The image is of snowcapped mountains.” The combined signature 147 comprises concatenated signatures of one or more sender encoded representations 133, the content description 130, and/or other data included in the content data 145 and can be used to validate the integrity of the content data 145.

The public key 142 and the private key 139 are part of an asymmetric cryptographic key-pair that can be used to authenticate content data 145 being transferred from a sender to a recipient. The cryptographic keys in the key-pair can be used by an entity or user to confirm or otherwise authenticate their relationship with or control over the content 124 being transferred. The key-pair can be generated using various approaches, such as elliptic curve cryptography (ECC) approaches or using the Rivest-Shamir-Adleman (RSA) algorithm.

Various applications or other functionality can be executed in the receiver computing environment 106. The components executed on the receiver computing environment 106 include a content receiver service 150, and other applications, services, processes, systems, engines, or functionality not discussed in detail herein.

The content receiver service 150 can be executed to obtain the content data 145 from a content sender service 121 and verify the integrity of the content 124 included in the content data 145 prior to use of the content 124. In various examples, the content receiver service 150 can comprise an AI gateway service that can act as an intermediary between the sender computing environment 103 and the receiver client device 112 and can be used to verify the integrity of the content 124 and content data 145 prior to use of the content 124 by the recipient.

Upon receiving the content data 145, the content receiver service 150 can generate a receiver encoded representation 153. For example, the content receiver service 150 can generate the receiver encoded representation 153 by applying the received content 124 in the content data 145 as an input to an AI encoder 136 that is trained to encode the content type of the received content 124. As illustrated in FIG. 1A, the AI encoder 136 can be stored in a repository 115 that is in data communication with the receiver computing environment 106. In other examples, as illustrated in FIG. 1B, the AI encoder 136 can be local to the receiver computing environment 106 and can be executed within the receiver computing environment 106.

In various examples, the receiver encoded representation 153 can comprise a latent space representation of the content 124. For example, the AI encoder 136 can be trained to generate a latent space representation of the content 124 that corresponds to a compressed representation of the content in the form of one or more feature vectors. The feature vectors can capture the important characteristics of the content 124 which can be used for comparison and/or reconstruction. Accordingly, the received content 124 can be reduced in size and/or compressed using the AI encoder 136.

In various examples, the content receiver service 150 can compare the sender encoded representation 133 with the receiver encoded representation 153 to determine similarities between the two encoded representations. When the receiver encoded representation 153 matches the sender encoded representation 133 included in the content data 145 within a predefined threshold level of similarity, the content receiver service 150 can verify the integrity of the received content 124. In various examples, the content receiver service 121 can compare the sender encoded representation 133 with the receiver encoded representation 153 using distance metrics to compare the feature vectors of the corresponding encoded representation. For example, the distance metrics can correspond to Euclidean distance (e.g., the straight-line distance between two points in the feature space), cosine similarity (e.g., the cosine of the angle between two vectors, indicating how similar they are in terms of direction), Manhattan distance (e.g., the sum of the absolute differences between the coordinates of the vectors) and/or other type of vector comparison measurement. If the comparison indicates that the similarity between the sender encoded representation and the receiver encoded representation 153 is within a predefined threshold, the content receiver service 150 can validate the content 124 received in the content data 145.

The content receiver service 150 can further validate that content data 145 by verifying the signature of the sender encoded representation and/or combined signature 147 associated with the content data 145. In various examples, the public key 142 associated with the sender of the content data 145 can be used to verify the signature of the sender encoded representation 133 and/or combined signature 147 associated with the content data 145. Using signature verification approaches, the content receiver service 150 can verify the signatures as can be appreciated.

In various examples, the content receiver service 150 can apply the sender encoded representation 133 to a trained AI decoder 156 to reconstruct the content 124. In various examples, the content receiver service 150 can apply the sender encoded representation 133 as an input to an AI decoder 156 that is trained to decode the content type of the content 124. As illustrated in FIG. 1A, the AI decoder 156 can be stored in a repository 115 that is in data communication with the receiver computing environment 106. In other examples, as illustrated in FIG. 1B, the AI decoder 156 can be local to the receiver computing environment 106 and can be executed within the receiver computing environment 106.

In various examples, the output of the AI decoder 156 can comprise a representation of the content 124. In some examples, the AI decoder 156 comprises a low-resolution decoder that can reconstruct the content 124 with a lower level of quality to reduce resource usage. Upon receiving the reconstructed content 124, the content receiver service 150 can apply the reconstructed content and the received content description 130 as inputs to a large language model (LLM) 159 to validate the description against the reconstructed image. For example, the LLM 159 can be trained to verify if the reconstructed content matches the content description 130 by determining if a comparison score is within a predefined threshold of similarity.

In response to verifying the sender encoded representation 133, the digital signatures (e.g., combined signature 147) and/or the content description 130, the content receiver service 150 can validate the integrity of the received content 124 and permit use of the content 124 by the receiving entity. In some examples, the content 124 can be used by the one or more applications within the receiver computing environment 106. In other examples, the content 124 can be processed and provided to the receiver client device 112 for use by the receiver client device 112.

Also, various data is stored in a receiver data store 162 that is accessible to the receiver computing environment 106. The receiver data store 162 can be representative of a plurality of receiver data stores 162, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the receiver data store 162 is associated with the operation of the various applications or functional entities described below. This data can include content data 145, a receiver encoded representation 153, a public key 142, an LLM 159, and potentially other data.

The content data 145 can represent data associated with content 124 that is received from the sender computing environment 103. The content data 145 can include content 124, a sender encoded representation 133, a content description 130, a combined signature 147, and/or other data. The content 124 can include text, images, graphics, audio, video, and/or other type of media or multimedia.

The sender encoded representation 133 can comprise the output of an AI encoder 136. For example, the AI encoder 136 can be trained to generate a latent space representation of the content 124 that corresponds to a compressed representation of the content in the form of one or more feature vectors. The feature vectors can capture the important characteristics of the content 124 which can be used for comparison and/or reconstruction. Accordingly, the content 124 can be reduced in size and/or compressed using the AI encoder 136.

The content description 130 can comprise a text description for the content and can be used for verification of the content 124. For example, if the content 124 comprises an image of snowcapped mountains, the content description 130 may include “The image is of snowcapped mountains.” The combined signature 147 comprises concatenated signatures of one or more sender encoded representations 133, the content description 130, and/or other data included in the content data 145 and can be used to validate the integrity of the content data 145.

The public key 142 corresponds to the public key 142 of the sender associated with the sender computing environment 103 and/or the sender client device 109. The public key 142 can be used by the content receiver service 150 to verify digital signatures and/or the combined signature 147 that are generated using the corresponding private key 139 to the public key 142.

The receiver encoded representation 153 can comprise the output of an AI encoder 136 where the input comprises the received content 124 from the sender computing environment 103. For example, the AI encoder 136 can be trained to generate a latent space representation of the received content 124 that corresponds to a compressed representation of the content in the form of one or more feature vectors. The feature vectors can capture the important characteristics of the received content 124 which can be used for comparison and/or reconstruction. Accordingly, the content 124 can be reduced in size and/or compressed using the AI encoder 136.

A large language model 159 can represent any language model that includes a neural network with many parameters (tens of thousands, millions, or sometimes even billions or more) that is trained on large quantities of unlabeled text using self-supervised learning or semi-supervised learning techniques. Some large language models 159 may be generative—that is they can generate new data based at least in part on patterns and structure learned from their input training data. Examples of large language models 159 include various versions of OPENAI's Generative Pre-trained Transformer (GPT) model (e.g., GPT-1, GPT-2, GPT-3, GPT-4, etc.), META's Large Language Model Meta AI (LLaMA), and GOOGLE's Pathways Language Model 2 (PaLM 2), among others. A large language model 159 can be configured to return a response to a prompt, which can be in a structured form (e.g., a request or prompt with a predefined schema and/or parameters) or in an unstructured form (e.g., free form or unstructured text).

In various examples, the LLM 159 of the present disclosure can be trained to compare a content description 130 with reconstructed content 124. Accordingly, the output of the LLM 159 can include a score or other type of output that indicates a level of similarity between the content description 130 and the reconstructed content 124. In various examples, the output of the LLM 159 can be used to further validate the content data 145 that is received from a sender computing environment 103.

The repository 115 can comprise a public or private repository storing trained AI encoder(s) 136 and AI decoder(s) 156 for use by third parties to generate latent encoded representations of content 124 and reconstruct content 124 from generated latent encoded representations of content 124. In various examples, the repository 115 can comprise a public repository that is accessible to any third party. In other examples, the repository 115 can comprise a private repository that is only accessible to permitted entities.

The AI encoder 135 comprises an artificial neural network architecture that is designed to compress or otherwise reduce the size of content 124 into a latent space representation by learning efficient representations of data for the purpose of dimensionality reduction. In various examples, the AI encoder 136 can be trained to generate a latent space representation of the content 124 that corresponds to a compressed representation of the content in the form of one or more feature vectors. The feature vectors can capture the important characteristics of the content 124 which can be used for comparison and/or reconstruction. Accordingly, the received content 124 can be reduced in size and/or compressed using the AI encoder 136. In various examples, the repository 115 can store multiple AI encoders 136 where each AI encoder 136 is trained to generate latent representations of the content 124 based at least in part on the type of content 124. For example, there can be an AI encoder 136 that is trained for audio and there can be another AI encoder 136 that is trained for images.

The AI decoder 156 can comprise a neural network architecture that is trained to reconstruct content 124 from a latent encoded representation. In some examples, the AI decoder 156 comprises a low-resolution decoder that can reconstruct the content 124 with a lower level of quality to reduce resource usage. In various examples, the repository 115 can store multiple AI decoders 156 where each AI decoder 156 is trained to reconstruct content 124 from latent representations of the content 124 based at least in part on the type of content 124. For example, there can be an AI decoder 156 that is trained for audio and there can be another AI decoder 156 that is trained for images.

The sender client device 109 and the receiver client device 112 are representative of a plurality of client devices that can be coupled to the network 118. The sender client device 109 and the receiver client device 112 can each include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The sender client device 109 and the receiver client device 112 can each include one or more displays 165, such as liquid crystal displays (LCDs), gas plasma-based flat panel displays, organic light emitting diode (OLED) displays, electrophoretic ink (“E-ink”) displays, projectors, or other types of display devices. In some instances, the display 165 can be a component of the sender client device 109 or the receiver client device 112 or can be connected to the sender client device 109 or the receiver client device 112 through a wired or wireless connection.

The sender client device 109 can be configured to execute various applications such as a sender client application 168 or other applications. The sender client application 168 can be executed in a sender client device 109 to access network content served up by the sender computing environment 103 or other servers, thereby rendering a user interface on the display 165. To this end, the sender client application 168 can include a browser, a dedicated application, or other executable, and the user interface can include a network page, an application screen, or other user mechanism for obtaining user input. The sender client device 109 can be configured to execute applications beyond the sender client application 168 such as email applications, social networking applications, word processors, spreadsheets, or other applications.

The receiver client device 112 can be configured to execute various applications such as a receiver client application 171 or other applications. The receiver client application 171 can be executed in a receiver client device 112 to access network content served up by the sender computing environment 103 or other servers, thereby rendering a user interface on the display 165. To this end, the receiver client application 171 can include a browser, a dedicated application, or other executable, and the user interface can include a network page, an application screen, or other user mechanism for obtaining user input. The receiver client device 112 can be configured to execute applications beyond the receiver client application 171 such as email applications, social networking applications, word processors, spreadsheets, or other applications.

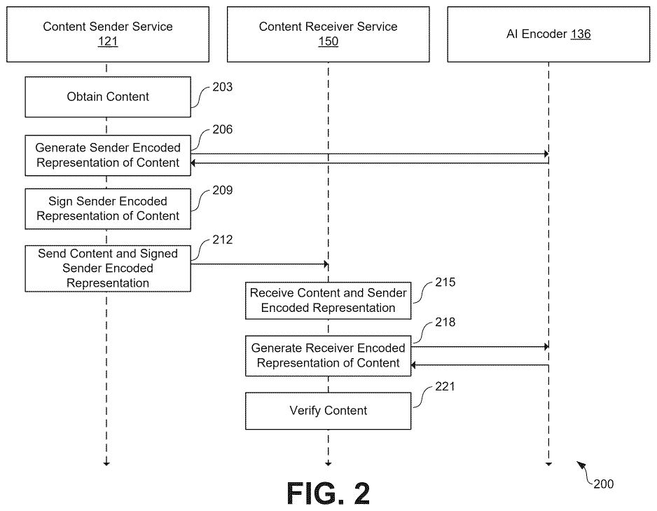

FIG. 2 illustrates a sequence diagram 200 that provides an example of the operation of the components of the network environment 100. It is understood that the sequence diagram 200 of FIG. 2 provides merely an example of the many different types of functional arrangements that can be employed to implement the operation of the depicted portion of the network environment 100. As an alternative, the sequence diagram 200 of FIG. 2 can be viewed as depicting an example of elements of a method implemented within the network environment 100. In particular, the sequence diagram 200 of FIG. 2 depicts the functionality associated with securely and efficiently transmitting content 124 between a sender and a receiver with added assurance regarding the integrity and similarity to the original form of the content 124.

Beginning with block 203, the content sender service 121 can obtain content 124 to be transmitted from a sender to a receiver. For example, the content sender service 121 can obtain the content 124 to be transferred from the sender data store 127 or from the sender client device 109. In some examples, the sender content service 121 can include an artificial intelligence gateway that is invoked in response to an application programming interface (API) call from the sender client device 109. In this example, the API call can include the content 124, a location of the content 124, a content description 130, a receiver identifier, and/or other information to prepare the content 124 for transfer to a receiving party.

At block 206, the content sender service 121 can generate a sender encoded representation 133 of the content 124. In various examples, the content sender service 121 can apply the content 124 as an input to an AI encoder 136 that is trained to encode the content type of the content 124. As illustrated in FIG. 1A, the AI encoder 136 can be stored in a repository 115 that is in data communication with the sender computing environment 103. In other examples, as illustrated in FIG. 1B, the AI encoder 136 can be local to the sender computing environment 103 and can be executed within the sender computing environment 103.

In various examples, the sender encoded representation 133 can comprise a latent encoded representation of the content 124. For example, the AI encoder 136 can be trained to generate a latent space representation of the content 124 that corresponds to a compressed representation of the content 124 in the form of one or more feature vectors. The feature vectors can capture the important characteristics of the content 124 which can be used for comparison and/or reconstruction. Accordingly, the content 124 can be reduced in size and/or compressed through the use of the AI encoder 136.

At block 209, the content sender service 121 can sign the sender encoded representation 133 by generating a digital signature. The content sender service 121 can generate a signature for the sender encoded representation 133 of the content 124 that is output from the AI encoder 136. For example, the content sender service 121 can use at least one of Rivest-Shamir-Adelman (RSA), digital signature algorithm (DSA), Elliptic Curve Digital Signature algorithm (ECDSA) or another digital signature algorithm to generate the digital signature of the encoded representation of the content 124. In some examples, the content sender service 121 can digitally sign the encoded representation using the private key 139 of a sender associated with the sender computing environment 103 and/or sender client device 109 and the corresponding public key 142 can be used by the receiving entity for validation.

At block 212, the content sender service 121 can send the content 124 and the signed sender encoded representation 133 to the content receiver service 150. In various examples, the content sender service 121 can generate content data 145 to transfer to the receiving entity. The content data 145 can include the content 124, the sender encoded representation 133, and/or other data.

At block 215, the content receiver service 150 can receive the content 124 and the signed sender encoded representation 133. In some examples, the content receiver service 150 can comprise an AI gateway service that can act as an intermediary between the sender computing environment 103 and the receiver client device 112 and can be used to verify the integrity of the content 124 and content data 145 prior to use of the content 124 by the recipient.

At block 218, the content receiver service 150 can generate a receiver encoded representation of the content 124. For example, the content receiver service 150 can generate the receiver encoded representation 153 by applying the received content 124 in the content data 145 as an input to an AI encoder 136 that is trained to encode the content type of the received content 124. As illustrated in FIG. 1A, the AI encoder 136 can be stored in a repository 115 that is in data communication with the receiver computing environment 106. In other examples, as illustrated in FIG. 1B, the AI encoder 136 can be local to the receiver computing environment 106 and can be executed within the receiver computing environment 106. Use of the same AI encoder model on both the sending and receiving sides ensures compatibility and reduces potential errors or inconsistencies that can arise from using different models. This helps maintain consistency across transmitted payloads and prevents unexpected interference in the received data.

At block 221, the content receiver service 150 can verify the content 124. In various examples, the content receiver service 150 can compare the sender encoded representation 133 with the receiver encoded representation 153 to determine similarities between the two encoded representations. When the receiver encoded representation 153 matches the sender encoded representation 133 included in the content data 145 within a predefined threshold level of similarity, the content receiver service 150 can verify the integrity of the received content 124. In various examples, the content receiver service 121 can compare the sender encoded representation 133 with the receiver encoded representation 153 using distance metrics to compare the feature vectors of the corresponding encoded representation. For example, the distance metrics can correspond to Euclidean distance (e.g., the straight-line distance between two points in the feature space), cosine similarity (e.g., the cosine of the angle between two vectors, indicating how similar they are in terms of direction), Manhattan distance (e.g., the sum of the absolute differences between the coordinates of the vectors) and/or other type of vector comparison measurement. If the comparison indicates that the similarity between the sender encoded representation and the receiver encoded representation 153 is within a predefined threshold, the content receiver service 150 can validate the content 124 received in the content data 145.

The content receiver service 150 can further verify that content 124 by verifying the signature of the sender encoded representation 133. In various examples, the public key 142 associated with the sender of the content data 145 can be used to verify the signature of the sender encoded representation 133. Using signature verification approaches, the content receiver service 150 can verify the signatures as can be appreciated. Once the data is verified, the content receiver service 150 can process the content 124 for use by the receiver computing environment 106 and/or the receiver client device 112. Thereafter, this portion of the process proceeds to completion.

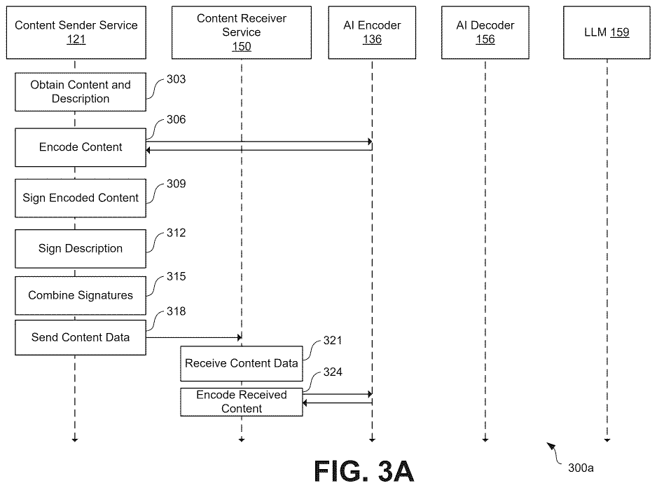

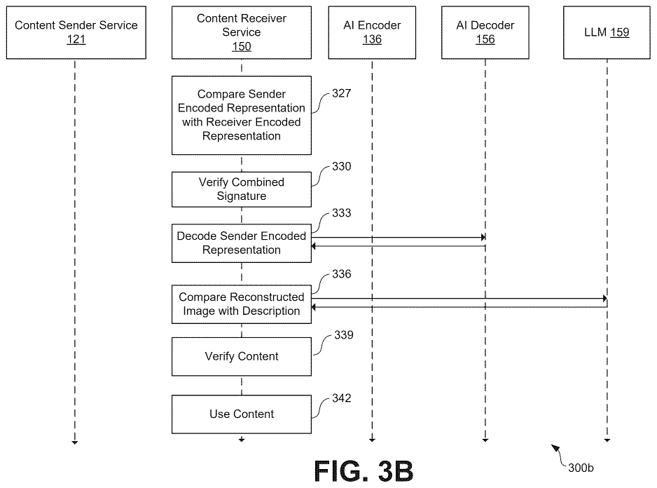

Moving on to FIGS. 3A and 3B, shown is a sequence diagram 300 (e.g., 300a or 300b) that provides an example of the operation of the components of the network environment 100. It is understood that the sequence diagram 300 of FIGS. 3A and 3B provides merely an example of the many different types of functional arrangements that can be employed to implement the operation of the depicted portion of the network environment 100. As an alternative, the sequence diagram 300 of FIGS. 3A and 3B can be viewed as depicting an example of elements of a method implemented within the network environment 100. In particular, the sequence diagram 300 of FIGS. 3A and 3B depicts the functionality associated with securely and efficiently transmitting content 124 and a content description 130 between a sender and a receiver with added assurance regarding the integrity and similarity to the original form of the content 124.

Beginning with block 303, the content sender service 121 can obtain content 124 and a content description 130 to be transmitted from a sender to a receiver. For example, the content sender service 121 can obtain the content 124 and content description 130 to be transferred from the sender data store 127 or from the sender client device 109. In some examples, the sender content service 121 can include an artificial intelligence gateway that is invoked in response to an application programming interface (API) call from the sender client device 109. In this example, the API call can include the content 124, a location of the content 124, a content description 130, a receiver identifier, and/or other information to prepare the content 124 for transfer to a receiving party.

At block 306, the content sender service 121 can generate a sender encoded representation 133 of the content 124. In various examples, the content sender service 121 can apply the content 124 as an input to an AI encoder 136 that is trained to encode the content type of the content 124. As illustrated in FIG. 1A, the AI encoder 136 can be stored in a repository 115 that is in data communication with the sender computing environment 103. In other examples, as illustrated in FIG. 1B, the AI encoder 136 can be local to the sender computing environment 103 and can be executed within the sender computing environment 103.

In various examples, the sender encoded representation 133 can comprise a latent encoded representation of the content 124. For example, the AI encoder 136 can be trained to generate a latent space representation of the content 124 that corresponds to a compressed representation of the content 124 in the form of one or more feature vectors. The feature vectors can capture the important characteristics of the content 124 which can be used for comparison and/or reconstruction. Accordingly, the content 124 can be reduced in size and/or compressed through the use of the AI encoder 136.

At block 309, the content sender service 121 can sign the sender encoded representation 133 by generating a digital signature. The content sender service 121 can generate a signature for the sender encoded representation 133 of the content 124 that is output from the AI encoder 136. For example, the content sender service 121 can use at least one of RSA, DSA, ECDSA or another digital signature to generate the digital signature of the encoded representation of the content 124. In some examples, the content sender service 121 can digitally sign the encoded representation using the private key 139 of a sender associated with the sender computing environment 103 and/or sender client device 109 and the corresponding public key 142 can be used by the receiving entity for validation.

At block 312, the content sender service 121 can sign the content description 130. For example, the content sender service 121 can apply a hash function to the content description 130 followed by the application of an encryption algorithm to generate the digital signature of the content description 130. In various examples, the private key 139 is used to generate the digital signature of the content description 130.

At block 315, the content sender service 121 can generate a combined signature 147. For example, the content sender service 121 can combine all the individual signatures (e.g., digital signatures for content 124, and encrypted hash for the content description 130 or text) into a single string or data structure. The content sender service 121 can then apply a secure cryptographic hash function to the concatenated string or combined data structure. Application of the secure cryptographic hash function can generate a unique and compact representation of the combined signatures. The content sender service 121 can then encrypt the resulting hash value using an asymmetric encryption algorithm (e.g., RSA, DSA, ECDSA, etc.). The encrypted hash serves as the combined signature 147 representing the integrity of all content types included in the content data 145.

At block 318, the content sender service 121 can send content data 145 to the receiving entity. In various examples, the content sender service 121 can generate content data 145 to transfer to the receiving entity. The content data 145 can include the content 124, the sender encoded representation 133, the combined signature 147, and/or other data.

At block 321, the content receiver service 150 can receive the content data 145 including the content 124, the signed sender encoded representation 133, and combined signature 147. In some examples, the content receiver service 150 can comprise an AI gateway service that can act as an intermediary between the sender computing environment 103 and the receiver client device 112 and can be used to verify the integrity of the content 124 and content data 145 prior to use of the content 124 by the recipient.

At block 324, the content receiver service 150 can generate a receiver encoded representation of the content 124. For example, the content receiver service 150 can generate the receiver encoded representation 153 by applying the received content 124 in the content data 145 as an input to an AI encoder 136 that is trained to encode the content type of the received content 124. As illustrated in FIG. 1A, the AI encoder 136 can be stored in a repository 115 that is in data communication with the receiver computing environment 106. In other examples, as illustrated in FIG. 1B, the AI encoder 136 can be local to the receiver computing environment 106 and can be executed within the receiver computing environment 106. Use of the same AI encoder model on both the sending and receiving sides ensures compatibility and reduces potential errors or inconsistencies that can arise from using different models. This helps maintain consistency across transmitted payloads and prevents unexpected interference in the received data.

At block 327, the content receiver service 150 can compare the sender encoded representation 133 with the receiver encoded representation 153. When the receiver encoded representation 153 matches the sender encoded representation 133 included in the content data 145 within a predefined threshold level of similarity, the content receiver service 150 can verify the integrity of the received content 124. In various examples, the content receiver service 121 can compare the sender encoded representation 133 with the receiver encoded representation 153 using distance metrics to compare the feature vectors of the corresponding encoded representation. For example, the distance metrics can correspond to Euclidean distance (e.g., the straight-line distance between two points in the feature space), cosine similarity (e.g., the cosine of the angle between two vectors, indicating how similar they are in terms of direction), Manhattan distance (e.g., the sum of the absolute differences between the coordinates of the vectors) and/or other type of vector comparison measurement. If the comparison indicates that the similarity between the sender encoded representation and the receiver encoded representation 153 is within a predefined threshold, the content receiver service 150 can validate the content 124 received in the content data 145.

At block 330, the content receiver service 150 can verify the combined signature 147. The combined signature 147 comprises concatenated signatures of one or more sender encoded representations 133, the content description 130, and/or other data included in the content data 145 and can be used to validate the integrity of the content data 145. For example, the public key 142 of the sender can be used by the content receiver service 150 to verify digital signatures and/or the combined signature 147 that are generated using the corresponding private key 139 to the public key 142.

At block 333, the content receiver service 150 can decode the sender encoded representation 133. For example, the content receiver service 150 can apply the sender encoded representation 133 to a trained AI decoder 156 to reconstruct the content 124. In various examples, the content receiver service 150 can apply the sender encoded representation 133 as an input to an AI decoder 156 that is trained to decode the content type of the content 124. As illustrated in FIG. 1A, the AI decoder 156 can be stored in a repository 115 that is in data communication with the receiver computing environment 106. In other examples, as illustrated in FIG. 1B, the AI decoder 156 can be local to the receiver computing environment 106 and can be executed within the receiver computing environment 106.

At block 336, the content receiver service 150 can compare the reconstructed content with the content description 130. For example, the content receiver service 150 can apply the reconstructed content and the received content description 130 as inputs to a large language model (LLM) 159 to validate the description against the reconstructed image. In various examples, the LLM 159 can be trained to compare the reconstructed content 124 with the content description 130 to determine if the reconstructed content matches the content description 130. In some examples, the determination can be based at least in part on determining if a comparison score is within a predefined threshold of similarity.

At block 339, the content receiver service 150 can verify the content data 145. In particular, the content receiver service 150 can verify the content according to the comparison of the sender encoded representation 133 and receiver encoded representation 153 at block 327, the verification of the combined signature 147 at block 330, and/or the comparison of the reconstructed content 124 with the content description 130 at block 336. Based on the results with one or more of these steps, the content receiver service 229 can verify the content data 145 and corresponding content 124 included in the content data 145.

At block 342, the content receiver service 150 can use the content 145 as intended. For example, in response to verifying the sender encoded representation 133, the digital signatures (e.g., combined signature 147), and/or the content description 130, the content receiver service 150 can validate the integrity of the received content 124 and permit use of the content 124 by the receiving entity. In some examples, the content 124 can be used by the one or more applications within the receiver computing environment 106. In other examples, the content 124 can be processed and provided to the receiver client device 112 for use by the receiver client device 112. Thereafter, this portion of the process proceeds to completion.

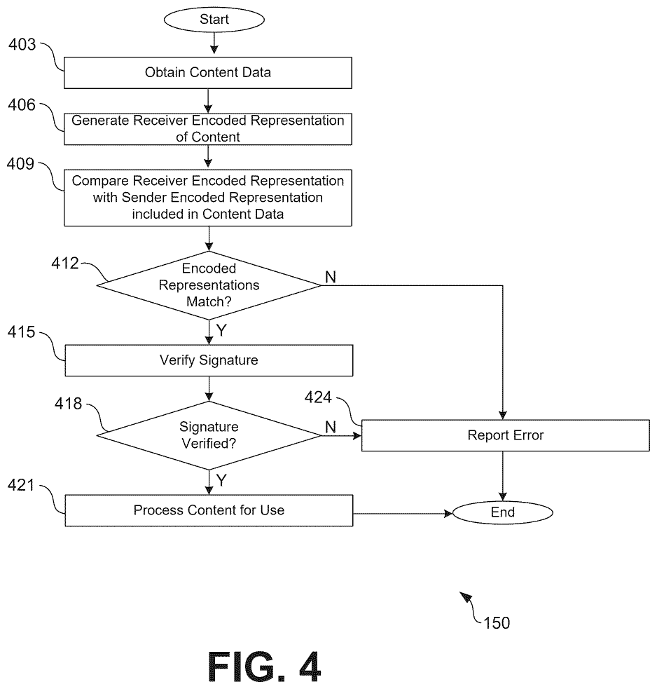

Referring next to FIG. 4, shown is a flowchart that provides one example of the operation of a portion of the content receiver service 150. The flowchart of FIG. 4 provides merely an example of the many different types of functional arrangements that can be employed to implement the operation of the depicted portion of the content receiver service 150. As an alternative, the flowchart of FIG. 4 can be viewed as depicting an example of elements of a method implemented within the network environment 100.

Beginning with block 403, the content receiver service 150 can obtain the content data 145 from a content sender service 121. In various examples, the content data can include the content 124, the signed sender encoded representation 133, a combined signature 147, and/or other data. In some examples, the content receiver service 150 can comprise an AI gateway service that can act as an intermediary between the sender computing environment 103 and the receiver client device 112 and can be used to verify the integrity of the content 124 and content data 145 prior to use of the content 124 by the recipient.

At block 406, the content receiver service 150 can generate a receiver encoded representation of the content 124. For example, the content receiver service 150 can generate the receiver encoded representation 153 by applying the received content 124 in the content data 145 as an input to an AI encoder 136 that is trained to encode the content type of the received content 124. As illustrated in FIG. 1A, the AI encoder 136 can be stored in a repository 115 that is in data communication with the receiver computing environment 106. In other examples, as illustrated in FIG. 1B, the AI encoder 136 can be local to the receiver computing environment 106 and can be executed within the receiver computing environment 106. Use of the same AI encoder model on both the sending and receiving sides ensures compatibility and reduces potential errors or inconsistencies that can arise from using different models. This helps maintain consistency across transmitted payloads and prevents unexpected interference in the received data.

At block 409, the content receiver service 150 can compare the sender encoded representation 133 with the receiver encoded representation 153. When the receiver encoded representation 153 matches the sender encoded representation 133 included in the content data 145 within a predefined threshold level of similarity, the content receiver service 150 can verify the integrity of the received content 124. In various examples, the content receiver service 121 can compare the sender encoded representation 133 with the receiver encoded representation 153 using distance metrics to compare the feature vectors of the corresponding encoded representation. For example, the distance metrics can correspond to Euclidean distance (e.g., the straight-line distance between two points in the feature space), cosine similarity (e.g., the cosine of the angle between two vectors, indicating how similar they are in terms of direction), Manhattan distance (e.g., the sum of the absolute differences between the coordinates of the vectors), and/or other type of vector comparison measurement.

At block 412, the content receiver service 150 determines if the encoded representations match. For example, if the comparison indicates that the similarity between the sender encoded representation and the receiver encoded representation 153 is within a predefined threshold, the content receiver service 150 can determine that the encoded representations match and proceed to block 415. Otherwise, the content receiver service 150 can determine that they do not match and proceed to block 424.

At block 415, the content receiver service 150 can verify the combined signature 147 and/or individual digital signatures. The combined signature 147 comprises concatenated signatures of one or more sender encoded representations 133, the content description 130, and/or other data included in the content data 145 and can be used to validate the integrity of the content data 145. For example, the public key 142 corresponding to the public key 142 of the sender can be used by the content receiver service 150 to verify digital signatures and/or the combined signature 147 that are generated using the corresponding private key 139 to the public key 142.

At block 418, the content receiver service 150 can determine whether the combined signature 147 and/or individual signatures are verified. If the signatures are verified, the content receiver service 150 proceeds to block 421. Otherwise, the content receiver service 150 proceeds to block 421.

At block 421, the content receiver service 150 can process the content 124 for use, as intended. For example, in response to verifying the sender encoded representation 133, the digital signatures (e.g., combined signature 147), and/or the content description 130, the content receiver service 150 can permit use of the content 124 by the receiving entity. In some examples, the content 124 can be used by the one or more applications within the receiver computing environment 106. In other examples, the content 124 can be processed and provided to the receiver client device 112 for use by the receiver client device 112. Thereafter, this portion of the process proceeds to completion.

At block 424, the content receiver service 150 can generate and report an error to the sender and/or receiver with respect to the verification of the content failing. In some examples, the error message is generated and transmitted to the sender computing environment 103, sender client device 109, and/or receiver client device 112. In other examples, the error message can be added to a log that can be accessed by the sender computing environment 103, sender client device 109, and/or receiver client device 112. Thereafter, this portion of the process proceeds to completion.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same sender computing environment 103 and receiver computing environment 106.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
obtain content data, the content data comprising content and a first encoded representation of the content from a sender device, the first encoded representation comprising a first latent space representation of the content;
encode the content to generate a second encoded representation of the content, the second encoded representation comprising a second latent space representation of the content;
compare the first encoded representation with the second encoded representation; and
validate the content based at least in part on a result from comparing the first encoded representation with the second encoded representation.

2. The system of claim 1, wherein the machine-readable instructions further cause the computing device to at least verify a signature of the first encoded representation based at least in part on a public key associated with the sender device.

3. The system of claim 1, wherein the content data further comprises a text description of the content, and the machine-readable instructions further cause the computing device to at least:
generate reconstructed content based at least in part on a trained artificial intelligence (AI) decoder and the first encoded representation of the content; and
compare the reconstructed content with the text description, the content further being validated based at least in part on comparing the reconstructed content with the text description.

4. The system of claim 3, wherein the machine-readable instructions further cause the computing device to at least apply the reconstructed content and the text description as inputs to a large language model (LLM), the content being validated based at least in part on an output of the LLM.

5. The system of claim 4, wherein the content data further comprises a combined digital signature associated with a first digital signature of the first encoded representation and a second digital signature of the text description.

6. The system of claim 1, wherein the content is encoded according to a trained artificial intelligence (AI) encoder.

7. The system of claim 6, wherein the trained AI encoder is local to the computing device.

8. The system of claim 6, wherein the trained AI encoder is located on a public repository in data communication with the computing device.

9. A method, comprising:
encoding received content to generate a first encoded representation of the received content, the first encoded representation comprising a first latent space representation of the received content;
comparing the first encoded representation with a second encoded representation that is received with the received content, the second encoded representation comprising a second latent space representation;
generating a reconstructed content based at least in part on the second encoded representation;
comparing the reconstructed content with a description of the received content; and
verifying an integrity of the received content based at least in part on a first result from comparing the first encoded representation with the second encoded representation and a second result from comparing the reconstructed content with the description.

10. The method of claim 9, further comprising obtaining content data from a sender device, the content data comprising the received content, the second encoded representation and the description.

11. The method of claim 10, wherein the content data further comprises a combined signature associated with the second encoded representation and the description.

12. The method of claim 11, further comprising verifying the combined signature based at least in part on a public key associated with the sender device.

13. The method of claim 9, wherein the received content is encoded using an artificial intelligence (AI) encoder, the AI encoder being trained to encode a type of content associated with the received content.

14. The method of claim 13, wherein the AI encoder is stored in a public repository, and further comprising:
sending an encode request to the AI encoder on the public repository, the encode request comprising the received content; and
receiving the first encoded representation from the AI encoder.

15. A non-transitory, computer-readable medium, comprising machine-readable instructions that, when executed by a processor of a computing device, cause the computing device to at least:
obtain content to send to a receiving device;
generate an encoded representation of the content based at least in part on an artificial intelligence (AI) encoder;
generate an encoded representation signature for the encoded representation based at least in part on a private key associated with a sender of the content;
generate content data including the content, the encoded representation, and the encoded representation signature; and
send the content data to the receiving device.

16. The non-transitory, computer-readable medium of claim 15, wherein the machine-readable instructions, when executed by the processor, further cause the computing device to at least obtain a description of the content, the content data comprising the description.

17. The non-transitory, computer-readable medium of claim 16, wherein the machine-readable instructions, when executed by the processor, further cause the computing device to at least:
generate a description signature by applying a hash function to the description; and
generate a combined signature for the encoded representation and the description by concatenating the encoded representation signature and the description signature, the content data comprising the combined signature.

18. The non-transitory, computer-readable medium of claim 15, wherein the content comprises at least one of an image, an audio, a video, or a document.

19. The non-transitory, computer-readable medium of claim 15, wherein the AI encoder is located in a public repository, and the machine-readable instructions, when executed by the processor, further cause the computing device to at least:
send an encode request to the AI encoder on the public repository, the encode request comprising the content; and
receive the encoded representation from the AI encoder.

20. The non-transitory, computer-readable medium of claim 15, wherein the content is obtained from a client device or a datastore in data communication with the computing device.
